(19) United States
(12) Patent Application Publication
(10) Pub. No.: US 2003/0112400 A1
(43) Pub. Date: Jun. 19, 2003

(54) Liquid crystal display device

(75) Inventors: Tomoo Izumi, Toyonaka-Shi (JP); Chiyoshi Nozaki, Otsu-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/300,316

(22) Filed: Nov. 20, 2002

(30) Foreign Application Priority Data
Nov. 29, 2001 (JP) 2001-365271

(51) Int. Cl. G02F 1/1343

(52) U.S. Cl. 349/141

(57) ABSTRACT

A liquid crystal display device has a pair of substrates, electrodes capable of selectively applying electric fields approximately vertical to and parallel with the substrates, and a liquid crystal composite showing a cholesteric phase and provided between the substrates. Permittivity anisotropy Δε of the liquid crystal satisfies the following conditions: Δε<0 and |Δε|>10.

### CROSS-REFERENCE TO RELATED APPLICATION

This application is based on Japanese Patent Application No. 2001-365271 filed in Japan on Nov. 29, 2001, the entire content of which is hereby incorporated by reference.

### BACKGROUND OF THE INVENTION

1. Field of the Invention

The present invention relates to a liquid crystal display device, particularly relates to the liquid crystal display device which holds liquid crystal showing a cholesteric phase between a pair of substrates and performs display utilizing selective reflection of the liquid crystal.

2. Description of the Related Art

In recent years, various liquid crystal display elements are developed and provided. In such liquid crystal elements, since a reflection type liquid crystal display element reflects an ambient light (external light) so as to perform display, display is possible by smaller power consumption than that of a transmission type liquid crystal display element requiring a back light. By utilizing this advantage, the reflection type liquid crystal device is adopted to display sections of a cellular phone, a mobile equipment and the like. Moreover, lowering of power consumption has been researched and developed heartily, and thus suggesting a reflection type liquid crystal display element or the like having memory property.

An operation mode of the reflection type liquid crystal display element having memory property is disclosed in SID (International Symposium Digest of Technical Paper), Vol. 29, p.p. 897. This operation mode is a system which switches an orientation state of chiral nematic liquid crystal between a planar state (light selection reflecting state) and a focal conic state (light transmitting state) and performs display.

Since the planar state and the focal conic state are stable states, respectively, when liquid crystal is once set to one of the states, that state is maintained semi-permanently as long as an external force is not applied. Namely, these states are practicable as a reflection type liquid crystal display element having memory property such that when an image is once displayed, the displayed image is maintained even if a power source is turned off.

The reflection type liquid crystal display element described in the above publication has a structure that chiral nematic liquid crystal having positive permittivity anisotropy is held between a pair of substrates having electrodes respectively. In this element, an electric field is liberated to a vertical direction with respect to the substrates by the electrodes, and the strength and/or applying time of the electric field are/is controlled, thereby changing the liquid crystal into a predetermined state (planar state or focal conic state).

When a voltage which is not less than a threshold voltage for releasing twist of the liquid crystal is applied to the liquid crystal for sufficient time, the entire liquid crystal is in a homeotropic state (a state that a longitudinal axis direction of liquid crystal molecules is vertical to the substrates). Since this state has no memory property, when an electric field is deleted, the liquid crystal is aligned in a twisted state. In the case where an electric field is deleted abruptly in the homeotropic state, the liquid crystal is brought into the planar state. In the case where an electric field is deleted gradually, the liquid crystal is brought into the focal conic state.

In addition, in the case where a pulse voltage, which releases twist of liquid crystal in the focal conic state and is not less than a threshold voltage (a voltage with a pulse width such that a part of the liquid crystal is in the homeotropic state), is applied to the liquid crystal, the liquid crystal in the homeotropic state is brought into the planar state after applying of the pulse voltage is ended. A width and/or a height of a pulse voltage are (is) controlled, thereby adjusting a ratio of liquid crystal to be in the planar state (display halftone).

However, in the liquid crystal display element using chiral nematic liquid crystal, since twist of liquid crystal molecules is released when an image is written so that the liquid crystal molecules are temporarily brought into the homeotropic state, a visible light is absorbed to a light absorbing layer on a rear surface of the element. As a result, the entire screen becomes black momentarily to be hardly seen, thereby arising a problem that image quality is deteriorated. The phenomenon that the twist is released is caused because the permittivity anisotropy of liquid crystal is positive.

The inventors of the invention found a method of applying a voltage not more than a threshold value for releasing twist of liquid crystal as a method of directly switching liquid crystal between the planar state and the focal conic state without releasing twist of liquid crystal, and went over practical use of the method. However, it was found that a sufficient response speed cannot be obtained by this driving method because an applying voltage is set to a low voltage. Namely, the performance of a driving driver (withstand voltage property) could not be displayed sufficiently.

### SUMMARY OF THE INVENTION

It is an object of the present invention to provide a liquid crystal display device which is capable of solving a deterioration of image quality at the time of updating an image and has a satisfactory response speed. Moreover, an object of the present invention is to provide a liquid crystal display device which is capable of displaying a performance of a driving driver sufficiently. Moreover, an object of the present invention is to provide a liquid crystal display device which is capable of directly changing liquid crystal between a planar state and a focal conic state.

In order to achieve at least one of the above objects, a liquid crystal display device of the present invention comprising a pair of substrates, liquid crystal composite showing a cholesteric phase provided between the substrates, and electrodes to which electric fields approximately vertical to and parallel with the substrates can be applied selectively. Permittivity anisotropy Δε of said liquid crystal composite satisfies the following conditions: Δε<0 and |Δε|>10.

In the above liquid crystal display device, when a voltage of not less than a threshold value which can change a direction of a helical axis is applied to the liquid crystal which has negative permittivity anisotropy and shows a cholesteric phase, the helical axis changes in a direction parallel with an electric field. In this case, in the liquid crystal with negative permittivity anisotropy showing a cholesteric phase, its twist is not released even if an applying voltage is high unlike liquid crystal having positive permittivity anisotropy. When the helical axis is changed in directions approximately vertical to and horizontal with the substrates without releasing twist of liquid crystal in such a manner, the liquid crystal can be changed directly between the planar state and the focal conic state not through a homeotropic state. Namely, since the liquid crystal is not, in the homeotropic state at the time of updating an image, it does not have a defect that the entire screen becomes black momentarily and image quality is deteriorated.

In the liquid crystal display device, since a comparatively high voltage can be applied to liquid crystal with negative permittivity anisotropy showing a cholesteric phase, a response speed becomes high. The comparatively high voltage is, here, not more than a withstand voltage of a driving driver, and enables a performance of the driver to be displayed sufficiently.

In the liquid crystal display device, the permittivity anisotropy Δε or the liquid crystal showing the cholesteric phase is negative and satisfies the condition: |Δε|>10. Here, it is more preferable that the permittivity anisotropy of the liquid crystal satisfies the condition of |Δε|>20.

The liquid crystal display device of the present invention may include a permittivity anisotropy adjusting material. The permittivity anisotropy adjusting material easily enables Δε of the liquid crystal to be negative and an absolute value to be large.

In addition, the electrode may include at least a pair of electrodes which are arranged in different plane positions on the same substrate. A lateral electric field can be generated easily between the pair of electrodes. An example of such electrodes is a pair of pectinate electrodes which are nested.

Further, the liquid crystal display device of the present invention has a driver which applys a voltage to the electrode so as to drive the device.

According to another aspect of the present invention, a liquid crystal display device comprising a first substrate formed with a first electrode, a second substrate formed with second and third electrodes, a liquid crystal composite showing a cholesteric phase provided between the first and second substrates, and a driver which selects a first state that a voltage is applied between the first electrode and the second electrode so that an electric field is generated in a direction penetrating through the first and second substrates or a second state that a voltage is applied between the second and third electrodes so that an electric field is generated in a direction along the first and second substrates so as to drive the device. Permittivity anisotropy Δε of the liquid crystal composite satisfies the following conditions: Δε<0 and |Δε|>10.

According to another aspect of the present invention, a liquid crystal display device comprising a first substrate formed with a first electrode, a second substrate formed with second and third electrodes, a liquid crystal composite having memory property and showing a cholesteric phase provided between the first and second substrates, and a driver which selects a first mode that a voltage is temporarily applied between the first and second electrodes so that an electric field is generated in a direction penetrating through the first and second substrates and the liquid crystal composite is set to a planar state or a second mode that a voltage is temporarily applied between the second and third electrodes so that an electric field is generated in a direction along the first and second substrates and the liquid crystal composite is set to a focal conic state so as to drive the device, and which maintains a display state by means of the memory property of the liquid crystal composite in a state that a voltage is not applied after the mode is selected. Permittivity anisotropy Δε of the liquid crystal composite satisfies the following conditions: Δε<0 and |Δε>10, and when the liquid crystal composite is switched from the planar state into focal conic state and from the focal conic state into the planar state, the liquid crystal composite is not in a homeotropic state.

### BRIEF DESCRIPTION OF DRAWINGS

These and other objects, advantages and features of the present invention will become apparent from the following description thereof taken in conjunction with the accompanying drawings in which:

FIG. 1 is an explanatory diagram of chiral nematic liquid crystal;

FIG. 2(A) is a cross-sectional view showing a state that a lateral electric field parallel with surfaces of substrates is generated in a liquid crystal display element according to an embodiment of the present invention;

FIG. 2(B) is a cross-sectional view showing a state that a longitudinal electric field vertical to the surfaces of the substrates is generated in the liquid crystal display element according to the embodiment of the present invention;

FIG. 3 is a cross-sectional view of a liquid crystal display element which is a first modified example in the embodiment of the present invention;

FIG. 4 is a cross-sectional view of a liquid crystal display element which is a second modified example in the embodiment of the present invention; and

FIG. 5 is a perspective view showing a structural example of an electrode for driving a simple matrix in the liquid crystal display element which is the second modified example in the embodiment of the present invention.

### DETAILED DESCRIPTION OF THE PREFERRED EMBODIMENTS

There will be explained below a liquid crystal display device according to embodiments of the present invention with reference to the attached drawings.

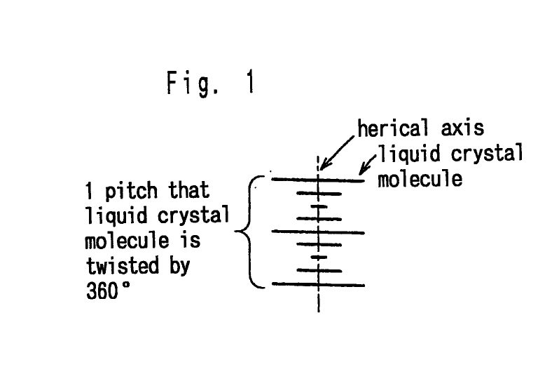

(Description of Principle, see FIG. 1)

A liquid crystal display device of the present invention uses liquid crystal showing a cholesteric phase as a display medium, and a typical example of such a kind of liquid crystal is chiral nematic liquid crystal.

The chiral nematic liquid crystal can be obtained by adding a predetermined amount of a chiral material to nematic liquid crystal. The chiral nematic liquid crystal is constituted so that, as shown in FIG. 1, bar-shaped liquid crystal molecules are generally arranged in a twisted manner so as to show a cholesteric phase.

When a light enters the liquid crystal, in the case where the light enters from a direction parallel with a helical axis, a light having a wavelength represented by λ=np is selectively reflected (planar state). Here, λ is a wavelength, n is an average refractive index of liquid crystal molecules, and p is a distance that the liquid crystal molecules are twisted by 360°. Meanwhile, in the case where a light enters from a direction vertical to the helical axis, the light does not substantially reflect but transmits (focal conic state). The selective reflection and transmission are utilized so that display is executed.

Incidentally, the liquid crystal molecules have bar shape but has anisotropy such that refractive index and permittivity are different in its longitudinal axis direction (major axis) and a direction vertical to the longitudinal axis direction (minor axis). The liquid crystal, in which the refractive index and permittivity of liquid crystal molecules in the major axial direction are larger than those in the minor axial direction, is called as liquid crystal with positive permittivity anisotropy. On the contrary, the liquid crystal, in which the refractive index of the liquid crystal molecules in the major axial direction is larger than that in the minor axial direction and permittivity in the major axial direction is smaller than that in the minor axial direction, is called as liquid crystal with negative permittivity anisotropy.

When a sufficiently high voltage is applied to the liquid crystal with negative permittivity anisotropy, the helical axis faces a random direction regardless of a direction of an electric field without releasing twist. This phenomenon is called as dynamic scattering. A threshold value exists in a voltage at which this phenomenon occurs, and a threshold voltage is indicated by Vd.

In addition, when a lower voltage than the threshold value Vd is applied to liquid crystal, the liquid crystal molecule moves so that the helical axis faces a direction parallel with a direction of the electric field without releasing twist. A threshold value exists also in a voltage for moving the helical axis, and this threshold voltage is indicated by Vp.

A relationship between the threshold voltages Vd and Vp is Vp<Vd. Moreover, even if a voltage lower than the threshold voltage Vp is applied to the liquid crystal, the liquid crystal molecules do not move. Namely, the helical axial direction does not change.

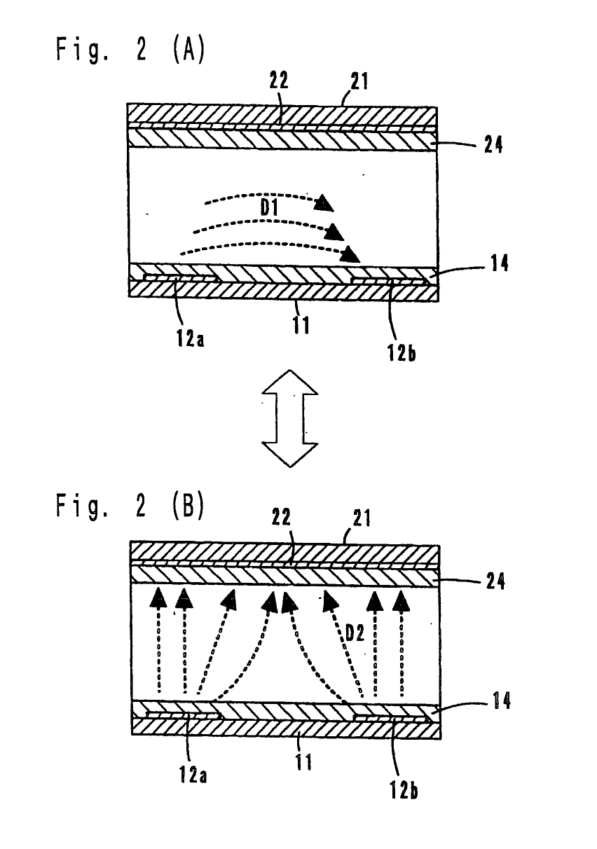

(First Embodiment, see FIG. 2)

As shown in FIG. 2, a liquid crystal display element 1 of the first embodiment is constituted so that electrodes 12a and 12b and an orientation control film 14 which are arranged in different plane positions are provided on a lower substrate 11, an electrode 22 and an orientation control film 24 are provided on an upper substrate 21, and chiral nematic liquid crystal, which is prepared by adding a chiral material to nematic liquid crystal so as to show a cholesteric phase at room temperature, is held between the substrates 11 and 21. FIG. 2 chemically shows a fraction of one-unit pixel.

Various liquid crystal can be used as long as they show cholesteric phase at room temperature, and typically chiral nematic liquid crystal, which is obtained by adding a chiral material to nematic liquid crystal so as to show a cholesteric liquid crystal phase at room temperature, is used.

An adding amount of the chiral material can be, for example, 8 to 45 weight % of an entire cholesteric liquid crystal composite. Liquid crystal having negative permittivity anisotropy Δε is used. As is clear from an experimental example, mentioned later, in the case where |Δε|>10, a satisfactory response speed could be obtained. More preferable response speed was obtained when the permittivity anisotropy |Δε|>20.

In order to obtain cholesteric liquid crystal in which Δε is negative and its absolute value is large, it is desirable that a permittivity anisotropic adjusting material is added. As the permittivity anisotropic adjusting material, a liquid crystal compound having a large dipole moment in the minor axial direction or a compound having similar structure to that of the liquid crystal compound can be used, and for example, dicyanohydroquinone derivative having a dicyanohydroquinone skeleton can be used. An adding amount of a permittivity anisotropic adjusting material can be not less than 20 weight % with respect to the entire cholesteric liquid crystal composite.

As a material of the substrates 11 and 21, various materials such as glass and a plastic film made of polyethersulfone (PES), polyethylene terephthalate (PET), polycarbonate (PC) or the like can be used. A material which is light weighted and thin is preferable. As a material of the electrodes 12a, 12b and 22, a transparent electrode material such as ITO or IZO can be used, and a non-transparent electrode material such as Al or Cu may be used for the electrodes 12a and 12b of the lower substrate 11. The electrodes 12a and 12b may be arranged in two-stepped manner via an insulating film 13 (see FIG. 5). The orientation control films 14 and 24 are provided so as to cover the electrodes 12a, 12b and 22. A conventional publicly-known material can be used for the insulating film 13 and the orientation control films 14 and 24.

Here, the electrodes 12a and 12b are pectinate electrodes which extend to a direction intersecting perpendicularly to a sheet surface of FIG. 2 and are arranged alternately in a right-left direction of the sheet surface. The electrode 22 is an electrode which has a width for at least one pixel and extends to the right-left direction of FIG. 2, and may be an entire surface electrode which covers an entire image display surface.

Further, in order to maintain a gap between the substrates 11 and 21 uniformly and constantly, corpuscles for a spacer or a pillar-shaped or wall-shaped resin structure is arranged between the substrates 11 and 21 as the need arises. Moreover, a light absorbing layer for absorbing a visible light is provided on a rear surface of the lower substrate 11. The substrate 11 itself may be provided with a visible light absorbing function.

In addition, it is preferable that a seal material is provided around the substrates 11 and 21 and liquid crystal is sealed between the substrates. Here, a rubbing process for the orientation control film 14 is not necessary topically, but a low-density rubbing process (for example, rubbing density is not more than 10) or a partial rubbing process is executed so that reflectance of liquid crystal in the planar state may be heightened. The orientation control film 14 itself may be omitted.

In the liquid crystal display element 1 having the above structure, when the chiral nematic liquid crystal having negative permittivity anisotropy is driven so that a voltage difference lower than Vd and higher than Vp is generated between the electrodes 12a and 12b provided on the substrate 11, as shown in FIG. 2(A), a lateral electric field D1 which is parallel with the surface of the substrate is generated, and the helical axis of the liquid crystal faces a direction approximately parallel with the surfaces of the substrates along the lateral electric field D1. Namely, the liquid crystal is in the focal conic state, and thus a light is transmitted therethrough.

Meanwhile, when the liquid crystal is driven so that the voltage difference which is lower than Vd and higher than Vp is generated between the electrodes 12a and 12b and the electrode 22, as shown in FIG. 2(B), a lengthwise electric field D2 which is vertical to the surfaces of the substrates is generated, and the helical axis of the liquid crystal faces a direction vertical to the surfaces of the substrates along the lengthwise electric field D2. Namely, the liquid crystal is in the planar state, and selective reflection with a predetermined wavelength occurs.

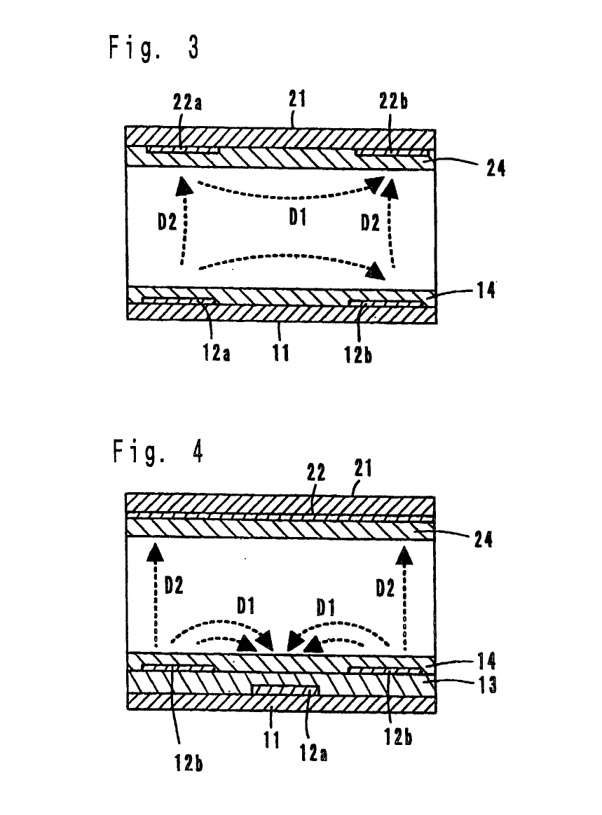

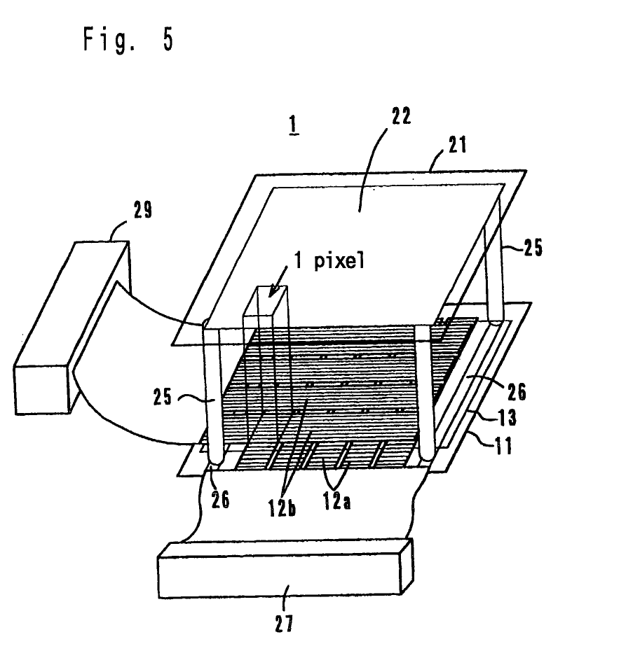

(Modified Example, see FIGS. 3 and 4)

Electrodes 12 and 22 provided to a pair of substrates 11 and 21 can adopt various patterns besides the pattern shown in FIG. 2. In short, a helical axis is controlled so that liquid crystal can be switched between the focal conic state and the planar state as long as the form is such that a plurality of electrodes which can control on/off of a voltage exist and an electric field to be formed between the substrates can be changed in a vertical direction and a parallel direction with respect to the surface of the substrates.

For example as shown in FIG. 3, a plurality of electrodes 12a, 12b, 22a and 22b may be provided to the substrates 11 and 21 so as to be opposed to each other. In this case, when the liquid crystal is driven so that a voltage difference is generated between the electrodes 12a and 12b and between the electrodes 22a and 22b, a lateral electric field D1 which is parallel with the surfaces of the substrates is generated. Moreover, when the liquid crystal is driven so that a voltage difference is generated between the electrodes 12a and 22a and between the electrodes 12b and 22b, a longitudinal electric field D2 which is vertical to the surfaces of the substrates is generated.

In addition, as shown in FIG. 4, the electrode 12a and the pectinate electrodes 12b which extend in a direction intersecting perpendicularly to the sheet surface and are arranged in a right-left direction of the sheet surface may be provided on the substrate 11 via an insulating film 13, and a wide electrode 22 may be provided on the substrate 21. In this case, when the liquid crystal is driven so that a voltage difference is generated between the electrodes 12a and 12b, the lateral electric field D1 which is parallel with the surfaces of the substrates is generated. Moreover, when the liquid crystal is driven so that a voltage difference is generated between the electrodes 12a and 22, the longitudinal electric field D2 which is vertical to the surfaces of the substrates is generated.

The positional relationship and the distance or applying voltages of the electrodes 12a, 12b and 22 shown in FIGS. 2, 3 and 4 are changed, thereby adjusting direction and strength of an electric field to be generated. For example, when a distance between the electrodes 12a and 12b is shortened, the strength of an electric field to be generated therebetween becomes large. Since the distance between the electrodes relates to a driving voltage, it is desirable that the distance is optimized according to physical properties of liquid crystal, a structure of a liquid crystal display element and the like.

(Structural Example of Simple Matrix Driving Electrode, see FIG. 5)

Here, one structural example of the electrodes 12a, 12b and 22, which are provided to the substrates 11 and 21 in the structure shown in FIG. 4 according to the first embodiment, is shown in FIG. 5.

Scanning electrodes 12a provided on the substrate 11 are formed as fine pectinate electrodes having length corresponding to one side of one pixel. Signal electrodes 12b are formed as fine pectinate electrodes which are grouped according to the other side of one pixel. A reset electrode 22 provided on the substrate 21 is formed as an entire surface electrode corresponding to an image display area.

The reset electrode 22 is connected to a scanning signal/reset, signal driving circuit 27 via contact lines 25 and 26. The scanning signal/reset signal driving circuit 27 is connected also to the scanning electrodes 12a. Moreover, the signal electrodes 12b are connected to a data signal driving circuit 29.

In the case where display is newly written or updated, firstly a voltage difference which is lower than Vd and not less than Vp is generated between the scanning electrodes 12a and the reset electrode 22 for chiral nematic liquid crystal having negative permittivity anisotropy. As a result, the helical axis of the liquid crystal faces a direction approximately vertical to the surfaces of the substrates, and the liquid crystal of all the pixels is reset to the planar state.

Next, a voltage difference which is lower than Vd and not less than Vp is generated between the scanning electrodes 12a and the signal electrodes 12b for pixels to which an image is written. As a result, the helical axis of liquid crystal faces a direction approximately parallel with the surfaces of the substrates, and only the liquid crystal of the pixels to which a voltage was applied is changed into the focal conic state. This image writing driving is executed by a simple matrix driving system in which while the scanning electrodes 12a are being selected per line, a pulse signal is given to the signal electrodes 12b based on image data.

Here in the case of the simple matrix driving, a voltage which is supplied from the driving circuit (crosstalk voltage) is applied also to a pixel (liquid crystal) which is not to be driven. However, if this crosstalk voltage is suppressed to be lower than a threshold voltage Vp, a state of the liquid crystal does not change.

After updating on the entire region where display is to be updated is ended, operations of the driving circuits are stopped, and applying of a voltage to the liquid crystal is stopped, thereby maintaining display utilizing the memory property of the liquid crystal.

In the electrode structural example shown in FIG. 5, the liquid crystal can be driven also by a division reset system in which after the scanning electrodes 12a are reset per line or plural lines of the pixels or reset simultaneously per plural lines, the helical axis is directed to an objective direction besides the driving by the above-mentioned collective reset system. Moreover, the liquid crystal can be driven also by an individual driving system in which the helical axis is directed to an objective direction per pixel without resetting.

### EXPERIMENTAL EXAMPLE

Next, an experimental example of the liquid crystal display device according to the present invention will be explained below.

The liquid crystal display device having the electrode structure shown in FIG. 5 is manufactured in such a manner that an ITO film is formed on the substrate 11 made of a polycarbonate film and the electrodes 12a and 12b are patterned by the photolithography method. As the orientation control film 14, AL8254 made by JSR CORPORATION is used so as to be formed by flexographic printing.

Meanwhile, an ITO film is formed on the substrate 21 made of a polycarbonate film, and the electrode 22 is provided by the photolithography method. As the orientation control film 24, AL8254 made by JSR CORPORATION is used so as to be formed by flexographic printing.

The above-mentioned substrates 11 and 21 are laminated in a state that chiral nematic liquid crystal and a gap holding member are held therebetween so that a liquid crystal panel is manufactured. As the gap holding member, Micropearl made by SEKISUI FINE CHEMICALS DIVISION, SEKISUI CHEMICAL CO., LTD. with particle diameter of 5 μm is used in order to prevent the distance between the substrates from being narrow, and pillar-shaped resin structures with slightly higher than a spacer diameter are arranged in a lattice pattern. Moreover, a peripheral edge portion of the substrates is sealed by a sealing material.

(Chiral Nematic Liquid Crystal Having Negative Permittivity Anisotropy)

As chiral nematic liquid crystal, four kinds of liquid crystal composites is prepared. The liquid crystal composite N1 has permittivity anisotropy Δε showing −5.4. The liquid crystal composite N2 has Δε showing −10.5. The liquid crystal composite N3 has Δε showing −15.5. The liquid crystal composite N4 has Δε showing −20.6. The used liquid crystal compound is ZLI-2806 (made by MERCK LTD.), the chiral materials are R-811, R-1011 and CB15 (made by MERCK LTD.), and permittivity anisotropic adjusting materials are represented by the following chemical structural formulas (A), (B) and (C). Their ratio of components are shown in Table 1.

TABLE 1

| | LIQUID | | | | | | | |
|---|---|---|---|---|---|---|---|---|
| | CRYSTAL | | | | PERMITTIVITY ANISOTROPIC | | | |
| | COMPOUND | CHIRAL MATERIAL | | | ADJUSTING MATERIAL | | | |
| | ZLI-2806 | R-811 | R-1011 | CB15 | A | B | C | Δε |
| LIQUID | 80 parts by | 16 | 4 parts by | | | | | −5.4 |
| CRYSTAL | weight | parts | weight | | | | | |
| COMPONENT | | by | | | | | | |
| N1 | | weight | | | | | | |
| LIQUID | 56 parts by | | 4 parts by | 16 parts by | 24 parts by | | | −10.5 |
| CRYSTAL | weight | | weight | weight | weight | | | |
| COMPONENT | | | | | | | | |
| N2 | | | | | | | | |
| LIQUID | 40 parts by | | 4 parts by | 16 parts by | 15 parts by | 15 parts by | 10 parts by | −15.5 |
| CRYSTAL | weight | | weight | weight | weight | weight | weight | |
| COMPONENT | | | | | | | | |
| N3 | | | | | | | | |
| LIQUID | 20 parts by | | 4 parts by | 16 parts by | 10 parts by | 35 parts by | 15 parts by | −20.5 |
| CRYSTAL | weight | | weight | weight | weight | weight | weight | |
| COMPONENT | | | | | | | | |
| N4 | | | | | | | | |

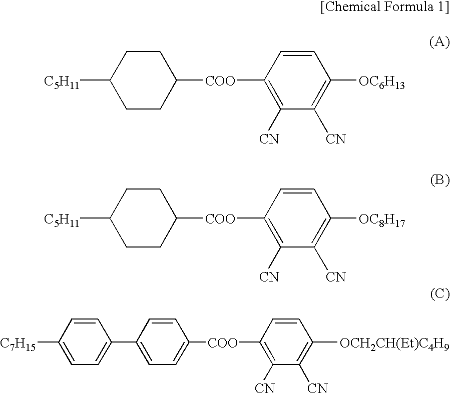

The liquid crystal composites N1, N2, N3 and N4 are held between a pair of substrates with transparent electrodes, and a voltage is applied between the electrodes so that strength of an electric field became 6 V/μm. The response time required for switching between the planar state and the focal conic state is measured.

As a result, the response time of N2 is 4 msec, the response time of N3 is 7 msec, and the response time of N4 is 8 msec. Namely, it is found that they are changed from the planar state to the focal conic state and from the focal conic state to the planar state for a short time. At the time of switching between both the states, twist is not released, and deterioration in image quality is not seen at the time of updating an image.

Meanwhile, in the liquid crystal composite N1 with Δε of −5.4, twist is not released, but the response time is 13 msec, namely, this is not necessarily satisfactory in the response speed.

(Chiral Nematic Liquid Crystal Having Positive Permittivity Anisotropy)

Further, as chiral nematic liquid crystal having positive permittivity anisotropy, three kinds of liquid crystal composites P1, P2 and P3 are prepared. The liquid crystal composite P1 has Δε showing 4.8. The liquid crystal composite P2 has Δε showing 9.8. The liquid crystal composite P3 has Δε showing 18.9. The used liquid crystal compounds are MLC6080 (made by MERCK LTD.), EV31LV (made by MERCK LTD.) and MN9014 (made by CHISSO CORPORATION). The chiral materials are R-811, R-1011 and CB15 (made by MERCK LTD.). Their ratio of components is shown in Table 2.

TABLE 2

| | LIQUID | | | | |
|---|---|---|---|---|---|
| | CRYSTAL | CHIRAL | | | |
| | COM- | MATERIAL | | | |
| | POUND | R-811 | R-1011 | CBl5 | ΔΣ |
| LIQUID | MLC6080 | 18 parts by | 2 parts | | 4.8 |
| CRYSTAL | 80 parts by | weight | by weight | | |
| COMPOSITE | weight | | | | |
| P1 | | | | | |
| LIQUID | EV31LV | 18 parts by | 2 parts | | 9.8 |
| CRYSTAL | 80 parts by | weight | by weight | | |
| COMPOSITE | weight | | | | |
| P2 | | | | | |
| LIQUID | MN9014 | | | 30 parts | 18.9 |
| CRYSTAL | 70 parts | | | by | |
| COMPOSITE | by weight | weight | | | |
| P3 | | | | | |

The liquid crystal composites P1, P2 and P3 are held between a pair of substrates with transparent electrodes, and a voltage is applied between both the electrodes so that strength of an electric field became 6 V/μm, thereby switching between the planer state and the focal conic state. As a result, twist of P2 and P3 is released, and a deterioration in image quality is seen at the time of updating an image. Moreover, it is found that twist of P1 is released, but the response time is 13 msec, namely, this is not necessarily satisfactory in the response speed.

(Another Embodiment)

The liquid crystal display device of the present invention is not limited to the above-mentioned embodiments, and can be changed variously within a scope of its gist.

Particularly a display device can be constituted by one layer of the display element shown in the embodiments, three laminated display elements for selectively reflecting R, G and B (full-color display), or two layered display elements for selectively reflecting with arbitrary wavelength. Further, the internal configurations of the driving circuits and their combination are arbitrary.

In addition, the embodiments exemplifies the simple matrix type liquid crystal element, but the present invention can be applied to an active matrix type liquid crystal display element having switching elements per pixel (for example, TFT: Thin Film Transistor or TFD: Thin Film Diode).

Further, as for the structure of the electrodes, various structures can be adopted besides the structures sown in FIGS. 2, 3 and 4. In short, a helical axial direction of liquid crystal can be controlled as long as at least two-directional electric fields can be formed between plural electrodes.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A liquid crystal display device comprising:
a pair of substrates;
electrodes capable of selectively applying electric fields approximately vertical to and parallel with the substrates; and
a liquid crystal composite showing a cholesteric phase and provided between the substrates, the permittivity anisotropy Δε of said liquid crystal satisfying the following conditions:
Δε<0

|Δε|>10

2. A liquid crystal display device as claimed in claim 1 wherein the permittivity anisotropy Δε of the liquid crystal composite satisfies the following condition:
relationship |Δε|>20

3. A liquid crystal display device as claimed in claim 1 wherein said liquid crystal composite includes a permittivity anisotropy adjusting material.

4. A liquid crystal display device as claimed in claim 3 wherein said permittivity anisotropy adjusting material has a large dipole moment in a direction vertical to the longitudinal axis direction of a liquid crystal molecule.

5. A liquid crystal display device as claimed in claim 3 wherein said permittivity anisotropy adjusting material is a dicyanohydroquinone derivative having a dicyanohydroquinone skeleton.

6. A liquid crystal display device as claimed in claim 3 wherein an adding amount of said permittivity anisotropy adjusting material is not less than 20 weight %.

7. A liquid crystal display device as claimed in claim 1 wherein said electrodes includes at least a pair of electrodes which are arranged in different plane positions on the same substrate.

8. A liquid crystal display device as claimed in claim 7 wherein at least one of said pair of electrodes is a pectinate electrode.

9. A liquid crystal display device as claimed in claim 7 wherein an insulating layer is provided between said pair of electrodes.

10. A liquid crystal display device as claimed in claim 1, further comprising:
a driver which applies a voltage to the electrodes to drive the display device.

11. A liquid crystal display device as claimed in claim 1, further comprising:
an orientation control film to which rubbing process is executed.

12. A liquid crystal display device as claimed in claim 1 wherein said liquid crystal composite is a chiral nematic liquid crystal obtained by adding a chiral material to nematic liquid crystal so as to show a cholesteric liquid crystal phase at room temperature.

13. A liquid crystal display device as claimed in claim 12 wherein an adding amount of the chiral material is 8 to 45 weight % of an entire cholesteric liquid crystal composite.

14. A liquid crystal display device as claimed in claim 12 wherein a plural kinds of chiral materials are added to the nematic liquid crystal.

15. A liquid crystal display device as claimed in claim 10 wherein a plurality of pixels are disposed in the form of matrix and said driver changes a display state of each pixel.

16. A liquid crystal display device comprising:
a first substrate formed with a first electrode;
a second substrate formed with second and third electrodes;
a liquid crystal composite showing a cholesteric phase provided between the first and second substrates; and
a driver which selects a first state that a voltage is applied between the first electrode and the second electrode so that an electric field is generated in a direction penetrating through the first and second substrates or a second state that a voltage is applied between the second and third electrodes so that, an electric field is generated in a direction along the first and second substrates so as to drive the device, wherein the permittivity anisotropy Δε of said liquid crystal composite satisfies the following conditions:
Δε<0

|Δε|>10

17. A liquid crystal display device comprising:
a first substrate formed with a first electrode;
a second substrate formed with second and third electrodes;
a liquid crystal composite having memory property and showing a cholesteric phase provided between the first and second substrates; and
a driver which selects a first mode that a voltage is temporarily applied between the first and second electrodes so that an electric field is generated in a direction penetrating through the first and second substrates and the liquid crystal composite is set to a planar state or a second mode that a voltage is temporarily applied between the second and third electrodes so that an electric field is generated in a direction along the first and second substrates and the liquid crystal composite is set to a focal conic state so as to drive the device, and which maintains a display state by means of the memory property of the liquid crystal composite in a state that a voltage is not applied after the mode is selected, wherein the permittivity anisotropy Δε of the liquid crystal composite satisfies the following conditions Δε<0 and |Δε|>10, and the liquid crystal composite is not in a homeotropic state when the liquid crystal composite is switched from the planar state into focal conic state and from the focal conic state into the planar state.
